(19) United States
(12) Patent Application Publication
(10) Pub. No.: US 2022/0083806 A1
(43) Pub. Date: Mar. 17, 2022

(54) METHOD AND SYSTEM FOR PRODUCT SEARCH BASED ON IMAGE RESTORATION

(71) Applicant: NHN Corporation, Gyeonggi-do (KR)

(72) Inventor: Myounghoon CHO, Gyeonggi-do (KR)

(21) Appl. No.: 17/464,562

(22) Filed: Sep. 1, 2021

(30) Foreign Application Priority Data
Sep. 16, 2020 (KR) 10-2020-0119342

(51) Int. Cl. G06K 9/34; G06K 9/32; G06K 9/62; G06K 9/20; G06T 7/11; G06T 5/00; G06K 9/46; G06N 3/04; G06F 16/53; G06F 16/583; G06Q 30/06

(52) U.S. Cl. CPC G06K 9/346; G06T 2207/20084; G06K 9/6215; G06K 9/2054; G06K 9/6267; G06T 7/11; G06T 5/005; G06K 9/46; G06N 3/04; G06F 16/53; G06F 16/5854; G06Q 30/0623; G06Q 30/0643; G06T 2207/20081; G06K 9/3233

(57) ABSTRACT

A method and a system for performing product search based on image restoration receive an input image including a target product to be searched; detect one or more objects including the target product from the input image through object detection; determine the target product among a plurality of products and obtain a main product image representing the target product; determine whether an obstacle, which is an object other than the target product, is included in the main product image; when the obstacle is included in the main product image, generate a loss image by removing the obstacle from the main product image; obtain a restored image by performing image restoration on the loss image using the deep learning; perform a product search, which searches for a product similar to the target product, based on the restored image; and output a result of the product search.

### CROSS REFERENCE TO RELATED APPLICATION

This application claims priority from and benefits of Korean Patent Application No. 10-2020-0119342, filed on Sep. 16, 2020, which is hereby incorporated by reference for all purposes as if fully set forth herein.

### BACKGROUND

### Technical Field

The present disclosure generally relates to a method and a system for performing product search based on image restoration. More particularly, some embodiments of the present disclosure relate to a method and a system for performing a product search by removing an obstacle not required for the product search from an image including a product to be searched based on deep learning of the corresponding image and performing image restoration on the obstacle-removed image.

### Related Art

In modern society, with the advances of various Information and Communications Technologies (ICT), it became possible for consumers to search or check and purchase a product provided by an online shopping mall server through a terminal such as a Personal Digital Assistant (PDA), a smartphone, and/or a desktop computer.

Here, the online shopping mall may refer to a device in which products may be purchased and sold online through a network such as the Internet.

These online shopping malls may require differentiated services that may increase their competitiveness as the number of individual online shopping malls increases rapidly in recent years, and the online shopping malls may need various solutions to provide differentiated services.

Moreover, due to the explosive increase in the number of products sold through an online shopping mall, an effective technique for searching a vast amount of products existing online is required.

Therefore, image-based product search to satisfy the needs of a user, namely, an online shopper, when the user searches an online shopping mall for a product but does not know the product name, has difficulty in finding the product through existing search methods (for example, a category-based or keyword-based search), or wants to check products similar to the desired product conveniently may be provided.

However, the conventional image-based product search technique stays at the level of simply recognizing an image used for a product search and providing the corresponding product. Therefore, when the corresponding image does not completely display the shape of the product to be searched, the conventional image-based product search technique may not guarantee the accuracy and quality of the product search.

In other words, a technology that can provide the convenience of basic usability of an online shopping mall as well as a search method differentiated from existing methods and increases user satisfaction by improving the quality of a product search result may be needed.

Meanwhile, machine learning is the research field of studying algorithms for prediction and/or classification based on properties learned through training data.

The artificial neural network is one field of the machine learning, and the accuracy of the machine learning is improved continually since the advent of big-data technology.

As described above, the neural network combined with the big data is called deep-learning.

Specifically, the deep learning may be defined as a set of machine learning algorithms that attempts high-level abstraction (e.g. a process that summarizes fundamental concepts or functions in a large amount of data or complex contents) through a combination of various nonlinear transformation methods.

In other words, the deep learning may enable computers to replace humans for analyzing a vast amount of data and grouping or classifying objects or data.

### PRIOR ART REFERENCES

### Patents

(Patent 1) Korean Patent No. 10-1852598 B1

### SUMMARY

Various embodiments of the present disclosure have been made in an effort to provide a method and a system that performs a product search by removing an obstacle not required for the product search from an image based on deep learning of the corresponding image used for the product search in an online shopping mall and performing image restoration on the obstacle-removed image.

Technical objects to be achieved by embodiments according to the present disclosure are not limited to the technical objects described above, and other technical objects may also be addressed.

A method and a system for product search based on image restoration according to an embodiment of the present disclosure performs a product search based on image restoration using deep learning by a product search application executed by a computing device, the method obtaining an input image including a target product to be searched; detecting at least one or more objects including the target product through object detecting from the input image; determining the target product from among the plurality of detected products and obtaining a main product image representing the target product; determining whether an obstacle, an object other than the target product, exists within the main product image; in the existence of the obstacle, removing the obstacle from the main product image and obtaining a loss image; obtaining a restored image by performing image restoration on the loss image based on the deep learning; performing a product search that searches for a product similar to the target product by inputting the restored image; and providing a result of the product search.

At this time, the main product image is an image including a predetermined area for an object representing the target object among at least one or more objects included in the input image.

Also, the obtaining the main product image includes determining, among bounding boxes for at least one or more objects detected from the input image based on the deep learning, an image of a bounding box area including the object of the target product as the main product image.

Also, the determining whether an obstacle, an object other than the target product, exists within the main product image determines that the obstacle exists therein when there is an overlapping area between a bounding box of a target product detected at the time of the object detecting and a bounding box of another object.

Also, the determining whether an obstacle, which is an object other than the target product, exists within the main product image includes performing semantic segmentation on the main product image to classify the main product image into a plurality of areas according to the respective labels and when a target product area designated by a label of the target product includes an area of another label, determining that the obstacle is included in the target product area.

Also, the obtaining the loss image includes obtaining an obstacle image generated based on an area representing the obstacle and obtaining a loss image that removes an area representing the obstacle from the main product image by performing image processing on the main product image based on the obstacle image.

Also, the obtaining the loss image includes classifying an area of the main product image into a first area indicated by a target product label and a second area indicated by an obstacle label through semantic segmentation; generating a mask for the second area indicated by the obstacle label; and obtaining a loss image by removing an area corresponding to the mask from the main product image.

Also the restored image is an image in which image restoration is performed on a predetermined loss area generated by removing an area representing the obstacle from the main product image.

Also, the obtaining the restored image by performing image restoration on the loss image based on the deep learning includes inputting the loss image into an image deep-learning neural network trained to perform inpainting and outputting a restored image that restores the area removed from the loss image by the image deep-learning neural network.

Also, the performing the product search that searches for a product similar to the target product by inputting the restored image includes extracting a feature vector by inputting the restored image into an image deep-learning neural network and searching a database that stores feature vectors of a plurality of products based on the extracted feature vector.

Also, the performing the product search for the target product includes detecting, from the database, a product having a feature vector of which the similarity to the feature vector of the restored image satisfies a predetermined criterion.

A method and a system for product search based on image restoration according to an embodiment of the present disclosure may perform deep learning on images used for a product search in an online shopping mall and perform an image-based product search based on an image restored after removing an obstacle in the existence of the corresponding obstacle at the time of the product search, thereby improving the accuracy and quality of an image-based product search service.

Also, a method and a system for product search based on image restoration according to an embodiment of the present disclosure may implement a product search service in an online shopping mall by performing image-based deep learning, thereby providing an effect of making the online shopping mall easy to use as well as increasing the competitiveness of the online shopping mall.

Also, a method and a system for product search based on image restoration according to an embodiment of the present disclosure may implement a product search service in an online shopping mall through deep learning using a trained deep-learning neural network, thereby detecting and providing a product search result more accurately and quickly.

The technical effects of the present disclosure are not limited to the technical effects described above, and other technical effects not mentioned herein may be understood clearly from the description below.

### BRIEF DESCRIPTION OF THE DRAWINGS

FIG. 1 is a conceptual diagram for illustrating a system for product search based on image restoration according to an embodiment of the present disclosure.

FIG. 2 illustrates an internal block diagram of a mobile-type computing device according to an embodiment of the present disclosure.

FIG. 3 illustrates an internal block diagram of a desktop-type computing device according to an embodiment of the present disclosure.

FIG. 4 illustrates an internal block diagram of a product search server according to an embodiment of the present disclosure.

FIG. 5 is a flow diagram illustrating a method for performing product search based on image restoration according to an embodiment of the present disclosure.

FIG. 6 illustrates an example of a main product image according to an embodiment of the present disclosure.

FIG. 7 is examples for illustrating image segmentation according to an embodiment of the present disclosure.

FIG. 8 illustrate an example of acquiring an obstacle image based on image segmentation according to an embodiment of the present disclosure.

FIG. 9 illustrates a method for acquiring a loss image and a restored image according to an embodiment of the present disclosure.

FIGS. 10 and 11 are examples of an image transformation process in a method for performing product search based on image restoration according to an embodiment of the present disclosure.

FIG. 12 is an example of graphic imagination of feature vectors by 2D transformation according to an embodiment of the present disclosure.

### DESCRIPTION OF EXEMPLARY EMBODIMENTS

Since the present disclosure may be modified in various ways and may provide various embodiments, specific embodiments will be depicted in the appended drawings and described in detail with reference to the drawings. The effects and characteristics of the present disclosure and a method for achieving them will be clearly understood by referring to the embodiments described later in detail together with the appended drawings. However, it should be noted that the present disclosure is not limited to the embodiment disclosed below but may be implemented in various other forms. In the following embodiments, the terms such as first and second are introduced to distinguish one element from the others, and thus the technical scope of the present disclosure should not be limited by those terms.

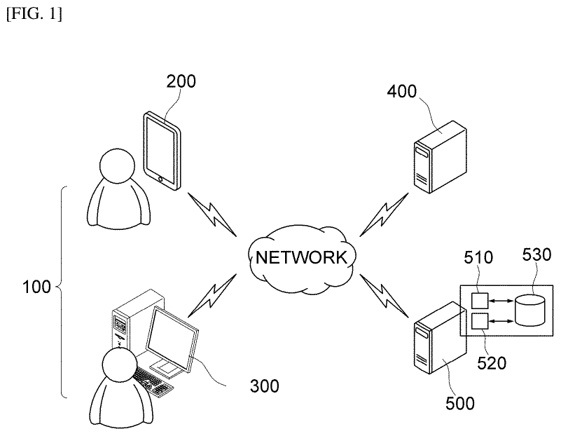

FIG. 1 is a conceptual diagram for illustrating a system for product search based on image restoration according to an embodiment of the present disclosure.

Referring to FIG. 1, a system for product search based on image restoration according to an embodiment of the present disclosure may include one or more computing devices 100, a product search server 400, and a shopping mall server 500.

In the embodiment, the computing device 100, the product search server 400, and the shopping mall server 500 may operate in conjunction with each other through execution of a product search application provided by the product search server 400 (hereinafter a “search application”) to perform deep learning of images used for a product search in an online shopping mall, remove an obstacle not required for the product search from the corresponding image, and provide a product search service (hereinafter a “produce search service”) based on image restoration that searches for a product by performing image restoration on the obstacle-removed image.

Specifically, in the embodiment, the computing device 100 may install a search application by downloading the application from the product search server 400 or the application provision server and provide a product search service by operating the search application.

At this time, according to the embodiment, the search application may be an application capable of providing a comprehensive online product search platform including a keyword-based search service, a category-based search service, and/or an image-based search service related to a product search in the online shopping mall.

In the embodiment below, descriptions are given regarding a process of performing a product search in an online shopping mall based on an image including a target product to be searched by the search application; however, the present disclosure is not limited to the descriptions and various alternate embodiments may also be applied.

Specifically, the search application according to the embodiment may obtain an input image, which is an image capturing a target product indicating a product to be searched, and product information providing descriptions of the corresponding target product.

Also, the search application may obtain a main product image representing the image of the target product among images of at least one or more objects included in the corresponding input image by performing object detection based on deep learning using the obtained input image and the product information.

Also, the search application according to the embodiment may determine whether an obstacle, which is an element that hinders a product search, exists in the corresponding main product image by performing deep learning on the obtained main product image.

And the search application may perform image processing for removing the obstacle when the corresponding obstacle exists in the corresponding main product image.

Also, the search application according to the embodiment may perform deep learning-based image restoration on the main product image in which a predetermined image loss has occurred due to the removal of the obstacle.

In addition, the search application may perform deep learning based on the restored image as above, through which a feature vector of the target product within the corresponding image may be detected.

Here, the feature vector according to the embodiment may mean a parameter (or variable) specifying a feature of an object within an image.

The feature vector according to the embodiment may include at least one or more of texture, fabric, shape, style, and/or color parameter, where each parameter value may be derived based on a deep learning neural network (for example, a pre-trained deep learning neural network for feature vector extraction). A detailed description of the feature vector will be given later.

Also, the search application according to the embodiment may perform an image-based product search based on the extracted feature vector and output or provide a result of the corresponding product search.

Meanwhile, the computing device 100, the product search server 400, and the shopping mall server 500 of FIG. 1 may be connected through a network.

Here, the network refers to a connection structure enabling exchange of information between individual nodes, such as the computing device 100, the product search server 400, and the shopping mall server 500, where examples of the network include a 3rd Generation Partnership Project (3GPP) network, a Long Term Evolution (LTE) network, a World Interoperability for Microwave Access (WiMAX) network, Internet, a Local Area Network (LAN), a Wireless Local Area Network (WLAN), a Wide Area Network (WAN), a Personal Area Network (PAN), a Bluetooth network, a satellite broadcasting network, an analog broadcasting network, and a Digital Multimedia Broadcasting (DMB) network; but are not limited to the above.

Computing Device 100

The computing device 100 according to the embodiment of the present disclosure may provide an environment for using a product search service and execute the search application capable of performing deep learning of images used for a product search of an online shopping mall within the product search service environment, removing an obstacle not required for the product search from the corresponding image, and searching for a product by performing image restoration on the obstacle-removed image.

According to the embodiment, the computing device 100 may include various types of computing devices 100 (for example, a mobile type or desktop type computing device) in which the search application is installed.

1. Mobile Type Computing Device 200

A mobile type computing device 200 according to the embodiment of the present disclosure may be a mobile device such as a smartphone or a tablet PC in which the search application is installed.

For example, examples of the mobile type computing device 200 may include a smartphone, a mobile phone, a digital broadcasting terminal, a Personal Digital Assistant (PDA), a Portable Multimedia Player (PMP), and a tablet PC.

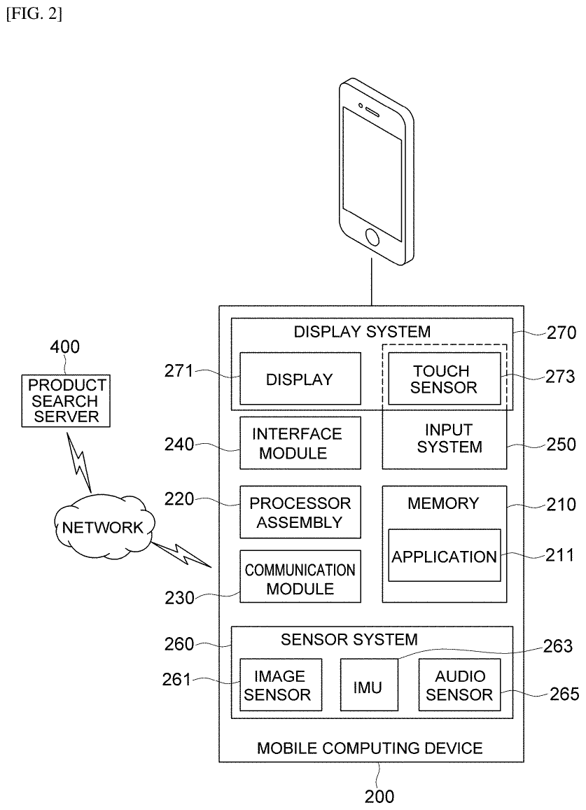

FIG. 2 illustrates an internal block diagram of a mobile-type computing device according to an embodiment of the present disclosure.

Referring to FIG. 2, a mobile type computing device 200 according to an exemplary implementation may include a memory 210, a processor assembly 220, a communication module 230, an interface module 240, an input system 250, a sensor system 260, and a display system 270. These constituting elements may be arranged to be included within a housing of the mobile type computing device 200 although it is not required.

Specifically, the memory 210 may be configured to store the search application 211. The search application 211 may store at least one or more of various application programs, data, and commands for providing an environment for implementing a product search service.

For example, the memory 210 may include an input image, product information, a main product image, an obstacle image, a loss image, a restored image, and/or feature vector information.

In other words, the memory 210 may store commands and data for generating an environment for the product search service.

Also, the memory 210 may include at least one or more non-volatile computer-readable storage media and volatile computer-readable storage media. For example, the memory 210 may include various storage devices such as a ROM, an EPROM, a flash drive, a hard drive, and web storage that performs a storage function of the memory 210 on the Internet.

The processor assembly 220 may include at least one or more processors capable of executing commands of the search application 211 stored in the memory 210 to perform various tasks for implementing an environment for the product search service.

The processor assembly 220 according to the embodiment may be configured to control the overall operation of constituting elements through the search application 211 of the memory 210 to provide the product search service.

The processor assembly 220 may include a Central Processing Unit (CPU) and/or a Graphics Processing Unit (GPU). Also, the processor assembly 220 may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, and electric units for performing miscellaneous functions.

The communication module 230 may include one or more devices for communicating with other computing devices (for example, the product search server 400). The communication module 230 may perform communication through a wired or wireless network.

Specifically, the communication module 230 may be configured to communicate with a computing device storing content sources for implementing an environment for the product search service and may communicate various user input components such as a controller that receives user inputs.

The communication module 230 according to the embodiment may be configured to transmit and receive various types of data related to the product search service to and from the product search server 400 and/or other computing devices 100.

The communication module 230 may transmit and receive data wired or wirelessly to and from at least one of a base station, an external terminal, and a particular server on a mobile communication network constructed through a communication apparatus compliant with technology standards or communication methods for mobile communication (for example, Long Term Evolution (LTE), Long Term Evolution-Advanced (LTE-A), 5G New Radio (NR), or WiFi) or a short distance communication method.

The sensor system 260 may include various sensors such as an image sensor 261, a position sensor (IMU) 263, an audio sensor 265, a distance sensor, a proximity sensor, and a touch sensor.

The image sensor 261 may be configured to capture an image of the physical space in the surroundings of the mobile type computing device 200.

The image sensor 261 according to the embodiment may capture an image (for example, an input image) related to the product search service.

Also, the image sensor 261 may be disposed on the front and/or rear surface of the mobile type computing device 200 to obtain an image of the surroundings along the disposed direction and capture a physical space through a camera disposed toward the outside of the mobile type computing device 200.

The image sensor 261 may include an image sensor device and an image processing module. Specifically, the image sensor 261 may process a still image or a video obtained by the image sensor device (for example, a CMOS or CCD sensor).

Also, the image sensor 261 may extract required information by processing a still image or a video obtained through the image sensor device using an image processing module and forward the extracted information to the processor.

The image sensor 261 may be a camera assembly including at least one or more cameras. The camera assembly may include at least one of a regular camera taking a photograph in the visible light band and a special camera such as an infrared camera or a stereo camera.

IMU 263 may be configured to detect at least one or more of a motion and an acceleration of the mobile type computing device 200. For example, the IMU 263 may comprise a combination of various positioning sensors such as accelerometers, gyroscopes, and magnetometers. Also, in conjunction with a position module such as GPS of the communication module 230, the IMU 263 may recognize spatial information of the physical space in the surroundings of the mobile type computing device 200.

Also, the IMU 263 may extract information related to the detection and tracking an eye gaze direction and a user's head motion based on the detected position and orientation.

Also, in some implementation, the search application 211 may determine the user's position and orientation within a physical space or recognize features or objects within the physical space by using the IMU 263 and the image sensor 261.

The audio sensor 265 may be configured to recognize a sound in the surroundings of the mobile type computing device 200.

Specifically, the audio sensor 265 may include a microphone capable of sensing a voice input of a user of the mobile type computing device 200.

The audio sensor 265 according to the embodiment may receive, from the user, voice data required for a product search service.

The interface module 240 may connect the mobile type computing device 20 to one or more different devices for communication. Specifically, the interface module 240 may include a wired and/or wireless communication device compatible with one or more different communication protocols.

The mobile type computing device 200 may be connected to various input-output devices through the interface module 240.

For example, the interface module 240, being connected to an audio output device such as a headset port or a speaker, may output an audio signal.

The audio output device may be connected through the interface module 240, but a different embodiment in which the audio output device is installed inside the mobile type computing device 200 may also be implemented.

The interface module 240 may comprise at least one of a wired/wireless headset port, an external charging port, a wired/wireless data port, a memory card port, a port connecting to a device equipped with an identification module, an audio Input/Output (I/O) port, a video I/O port, an earphone port, a power amplifier, an RF circuit, a transceiver, and other communication circuits.

The input system 250 may be configured to detect a user input (for example, a gesture, a voice command, a button operation, or other type of input) related to a product search service.

Specifically, the input system 250 may include a button, a touch sensor, and an image sensor 261 that receives a user's motion input.

Also, the input system 250, being connected to an external controller through the interface module 240, may receive a user's input.

The display system 270 may be configured to output various information related to a product search service as a graphic image.

The display system 270 may include at least one of a Liquid Crystal Display (LCD), a Thin Film Transistor-Liquid Crystal Display (TFT-LCD), an Organic Light-Emitting Diode (OLED), a flexible display, a three-dimensional (3D) display, and an electronic ink (e-ink) display.

The constituting elements may be disposed within a housing of the mobile type computing device 200 although it is not required, and a user interface may include a touch sensor 273 on a display 271 configured to receive a user's touch input.

Specifically, the display system 270 may include the display 271 outputting an image and a touch sensor 273 detecting a user's touch input.

The display 271 may be implemented as a touch screen by forming a layered structure or being integrated with the touch sensor 273. The touch screen may not only function as a user input unit providing an input interface between the mobile type computing device 200 and the user but also provide an output interface between the mobile type computing device 200 and the user.

2. Desktop Type Computing Device 300

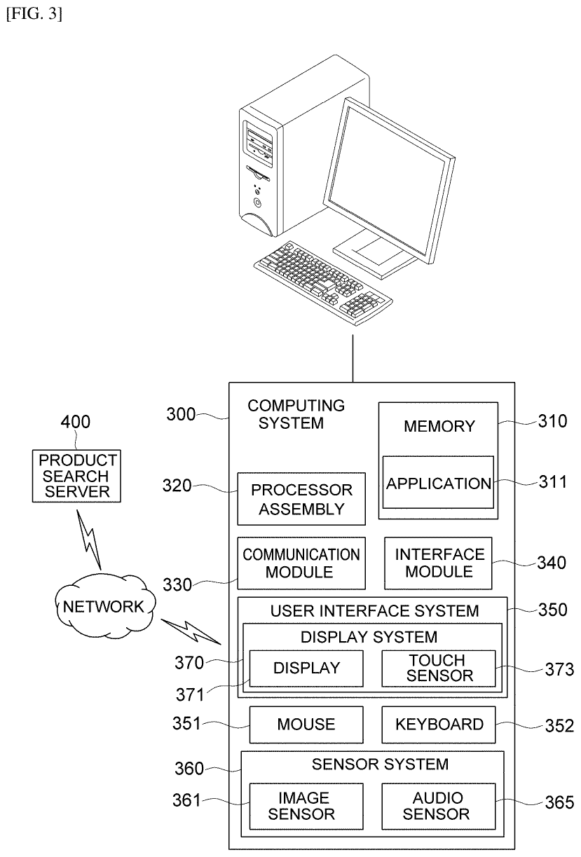

FIG. 3 illustrates an internal block diagram of a desktop-type computing device according to an embodiment of the present disclosure.

In describing the constituting elements of a desktop type computing device 300, repeated descriptions are substituted by the descriptions of the corresponding constituting elements of the mobile type computing device 200, and descriptions are given mainly to the difference from the mobile type computing device 200.

Referring to FIG. 3, the desktop type computing device 300 may further include a device equipped with a program for executing a product search service based on wired/wireless communication, such as a fixed desktop PC, a laptop computer, or a ultrabook in which the search application 311 is installed.

Also, the desktop type computing device 300 may receive a user input (for example, a touch input, a mouse input, a keyboard input, a gesture input, and a motion input using a guide tool) using a user interface system 350.

The desktop type computing device 300 according to an embodiment may obtain a user input by connecting the user interface system 350 to at least one device such as a mouse 351, a keyboard 352, a gesture input controller, an image sensor 361 (for example, a camera), and an audio sensor 365 via various communication protocols.

Also, the desktop type computing device 300 may be connected to an external output device through the user interface system 350, for example, a display device 370 or an audio output device.

Also, the desktop type computing device 300 according to the embodiment may include a memory 310, a processor assembly 320, a communication module 330, a user interface system 350, and an input system 340. These constituting elements may be included within a housing of the computing device 100, 300.

Descriptions of the constituting elements of the desktop type computing device 300 are substituted by the descriptions given to the constituting elements of the mobile type computing device 200.

Since the constituting elements of FIGS. 2 and 3 according to the present embodiment may not be essential to implement the computing device 100, the computing device 100 according to the present disclosure may have a greater or fewer number of constituting elements than listed above.

Product Search Server 400

A product search server 400 according to an embodiment of the present disclosure may perform a series of processes for providing a product search service.

Specifically, the product search server 400 may provide the product search service by exchanging required data with the computing device 100 to operate the search application in the computing device 100.

More specifically, the product search server 400 according to the embodiment may provide an environment in which the search application may operate in the computing device 100.

Also, the product search server 400 may perform image deep-learning required for a product search service.

Also, the product search server 400 according to the embodiment may perform a product search on an online shopping mall based on a predetermined image.

Also, the product search server 400 may collect and manage various types of data required for the product search service.

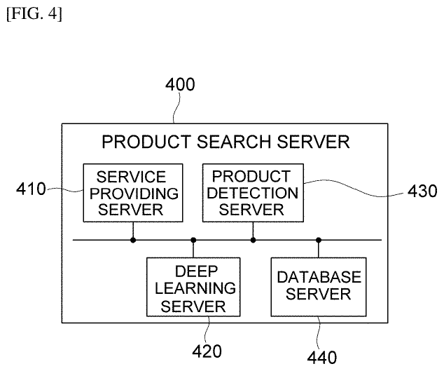

FIG. 4 illustrates an internal block diagram of a product search server according to an embodiment of the present disclosure.

More specifically, referring to FIG. 4, a product search server 400 may include a service providing server 410, a deep learning server 420, a product detection server 430, and a database server 440.

At this time, depending on embodiments, the respective constituting element may be implemented by separate devices different from the product search server 400 or may be implemented inside the product search server 400. In what follows, each constituting element may be included in the product search server 400, but the present disclosure is not limited to the assumption.

Specifically, the service providing server 410 may provide an environment in which the search application may operate in the computing device 100.

In other words, the service providing server 410 may provide an environment in which the search application that provides a product search service based on image restoration may operate in the computing device 100.

To this end, the service providing server 410 may include an application program, data, and/or commands for implementing a search application.

Also, the deep learning server 420 may perform image deep-learning required for a product search service in conjunction with an image deep-learning neural network.

Here, the image deep-learning neural network may include at least one of a Convolution Neural Network (CNN), for example, a U-net CNN and a Mask R-CNN.

According to the embodiment, the deep learning server 420 associated with an image deep-learning neural network may perform, based on the image input to the image deep-learning neural network, a functional operation using image processing techniques, such as object detection, segmentation, inpainting, feature map extraction, and/or feature vector detection. Detailed descriptions of the functional operation will be given later.

Also, the product detection server 430 may provide a product search service for an online shopping mall performed based on a predetermined image.

The product detection server 430 according to the embodiment may remove an obstacle included in a main product image including a target product to be searched and perform a product search on the online shopping mall based on an image obtained by applying image restoration to the main product image in which a predetermined loss has occurred. The product detection server 430 may detect, obtain, and provide a product corresponding to the target product included in the corresponding image from the corresponding online shopping mall through the operation above.

Also, the database server 440 may store and manage various application programs, applications, commands, and/or data for implementing the product search service.

The database server 440 according to the embodiment may store and manage various types of images and/or their information including an input image, product information, a main product image, an obstacle image, a loss image, a restored image, and/or feature vector information.

In particular, the database server 440 according to the embodiment may include a feature vector database for storing and managing information of feature vectors for each product of the shopping mall server 500.

Specifically, the database server 440, in conjunction with at least one or more shopping mall servers 500, may construct a feature vector database that stores information of feature vectors of each of at least one or more products provided by each shopping mall server 500.

At this time, the information of feature vectors for each of at least one or more products provided by each shopping mall server 500 may be obtained based on deep learning of the image of the corresponding product.

As described above, a series of functional operations for acquiring a feature vector of the corresponding image by performing image-based deep learning will be described in detail with reference to a method for product search based on image restoration to be described below.

Meanwhile, the product search server 400 including the constituting elements above may comprise one or more of at least one or more service providing servers 410, the deep learning server 420, the product detection server 430, and/or the database server 440. The product search server 400 may include one or more processors for data processing and one or more memories for storing commands for providing a product search service.

Also, according to the embodiment of the present disclosure, the product search server 400 may be configured to perform image deep-learning required for a product search service, perform a product search based on a predetermined image, and collect and manage various data required for the product search service. However, depending on embodiments, different implementation may also be made such that the computing device 100 performs part of the functional operations performed by the product search server 400.

Shopping Mall Server 500

A shopping mall server 500 according to an embodiment of the present disclosure may perform a series of processes for providing an online shopping mall service.

More specifically, the shopping mall server 500 according to the embodiment may provide the computing device 100 with an environment for providing an e-commerce online shopping mall service in which a user may order or sell a product through the network.

Also, the shopping mall server 500 may transmit and receive various types of data required for a product search service to and from the computing device 100 and/or the product search server 400.

The shopping mall server 500 according to the embodiment may transmit information on a plurality of products (for example, a product image and/or product information) on an online shopping mall to the computing device 100 and/or the product search server 400, and may receive information related to the needs for a specific product on the online shopping mall (for example, information on the product searched from the corresponding online shopping mall) from the computing device 100 and/or the product search server 400.

Also, the shopping mall server 500 may store at least one or more of application programs, data, and commands required for functional operations related to an online shopping mall service.

According to the embodiment, the shopping mall server 500 may store and manage product images and/or product information of at least one or more products on the online shopping mall.

More specifically, referring to FIG. 1, the shopping mall server 500 may include a shopping mall service providing server 510, a product management server 520, and a data storage server 530.

Here, the shopping mall service providing server 510 may provide an environment that enables an online shopping mall service to operate on a computing device.

In other words, the shopping mall service providing server 510 may provide an environment for implementing an online shopping mall service providing an online shopping mall which is a virtual shop where a product may be bought or sold on the Internet using a computing device 100.

The shopping mall service providing server 510 according to the embodiment may include various application programs, data, and/or commands capable of implementing a service provided in conjunction with an online shopping mall service.

Also, the product management server 520 may perform a management function for at least one or more products provided based on an online shopping mall service.

The product management server 520 according to the embodiment may manage a product name, a product image, a product price, and/or remaining quantities of the product.

Also, the data storage server 530 may store and manage various application programs, applications, commands, and/or data for implementing an online shopping mall service.

For example, the data storage server 530 may store and manage personal information, shopping information, and/or order information for each user who uses an online shopping mall service by matching the information to the corresponding user account.

The shopping mall server 500 including the constituting elements above may comprise at least one or more of the shopping mall service providing server 510, the product management server 520, and/or the data storage server 530, and may include one or more processors for data processing and one or more memories for storing commands for providing an online shopping mall service.

Method for Product Search Based on Image Restoration

In what follows, a method for product search based on image restoration according to an embodiment of the present disclosure will be described in detail with reference to appended drawings. In the embodiment below, it is assumed that the computing device 100 is a mobile-type computing device 200. However, the present disclosure is not limited to the assumption above.

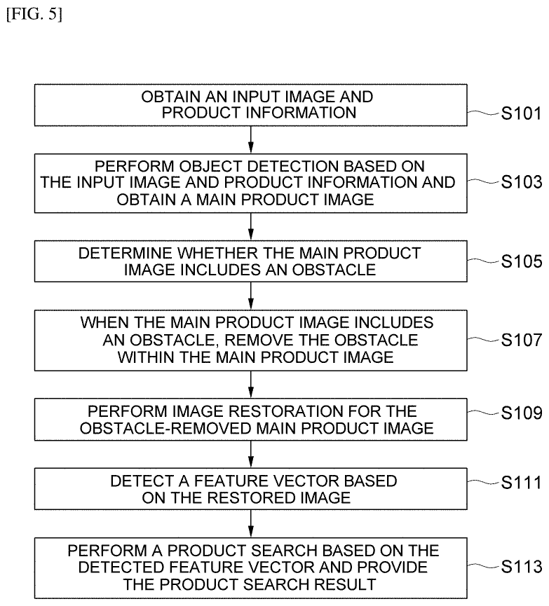

FIG. 5 is a flow diagram illustrating a method for performing product search based on image restoration according to an embodiment of the present disclosure.

Referring to FIG. 5, the mobile-type computing device 200 according to the embodiment of the present disclosure may perform deep learning on the image used for a product search in an online shopping mall, remove an obstacle not required for the product search from the corresponding image through the deep learning, and execute the search application 211 capable of searching for a product by performing image restoration on the obstacle-removed image or running the search application 211 in the background mode.

Then, the search application 211 executed or run in the background mode may obtain an input image of a target product to be searched and product information on the target product (step S101).

According to the embodiment, the input image may be, for example, but not limited to, an image capturing the target product to be searched.

Also, the product information according to the embodiment may be information that describes or relates to the target product, and include information of a category of the target product (for example, information that classifies a product into a top, bottom, dress, or swimsuit).

Specifically, the search application 211 according to the embodiment may provide an image-based search interface through which an image and product information of a target product to be searched can be input by a user.

Also, the search application 211 may acquire an input image of a target product and the product information on the target product based on the user input through the provided search interface.

Also, the search application 211 according to the embodiment may be configured to perform object detection and obtain the main product image based on the received input image and the product information (step S103).

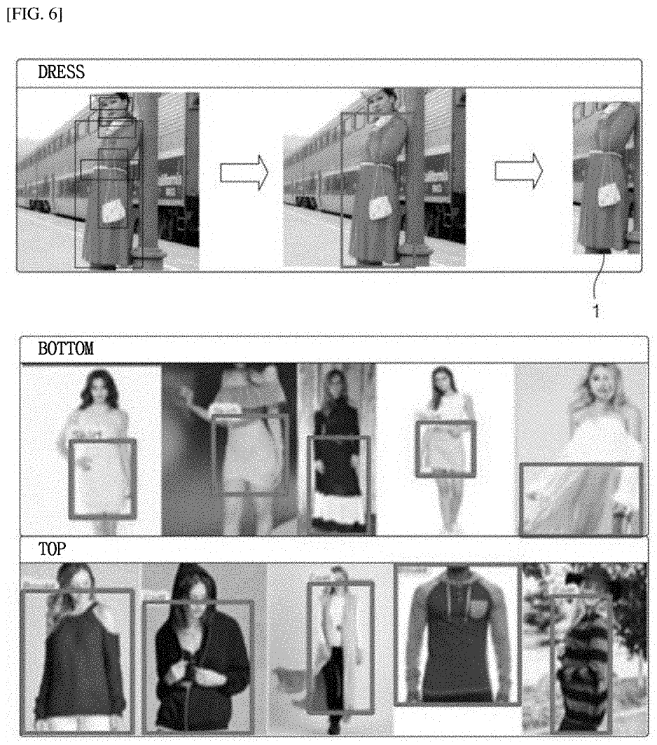

FIG. 6 illustrates an example of a main product image according to an embodiment of the present disclosure.

Referring to FIG. 6, the main product image 1 according to the embodiment may be an image including a predetermined area (e.g. a partial area of the input image) configured based on an object representing the target product determined to be the product to be searched by a user among at least one or more objects included in the input image.

At this time, the main product image 1 may be obtained based on bounding boxes of at least one or more objects detected from the input image.

Here, the bounding box may be a box formed by boundaries of a predetermined area (e.g. a partial area of the input image) configured based on each of at least one or more objects included in the input image.

Specifically, the search application 211 according to the embodiment may be configured to perform image deep-learning based on the obtained input image in conjunction with the product search server 400 or by the application's own process.

Specifically, the search application 211 may perform image deep-learning that performs object detection on the input image using an image deep-learning neural network.

And the search application 211 may detect at least one or more objects included in the corresponding input image through the object detection.

Also, the search application 211 according to the embodiment may generate a bounding box that indicates boundaries of a predetermined area (e.g. a partial area of the input image) configured based on each of the detected objects (for example, a rectangular box that indicates boundaries of a area surrounding the corresponding object).

At this time, the search application 211 according to the embodiment may use an image deep-learning neural network used for the object detection by training the network to be optimized for extracting an object related to fashion products from at least one or more objects included in an image.

In other words, the search application 211 may perform the object detection using the pre-trained image deep-learning neural network to specify that at least one or more objects detected from the input image correspond to a fashion-related product and to generate a bounding box for the corresponding fashion product.

For example, the search application 211 may operate in conjunction with a fashion detector, an image deep-learning neural network trained to be optimal for extracting a fashion-related object.

And the search application 211 may detect a fashion-related object and a predetermined area (e.g. a partial area of the input image) occupied by the corresponding object within the input image in conjunction with the fashion detector.

Also, the search application 211 may perform fashion detection by generating a bounding box for each detected fashion-related object.

At this time, an example of the fashion detector may include a first convolution neural network (Conv 1) that passes an input image to a convolution layer at least once and a second convolution neural network (Conv 2) composed of a region of interest (RoI) pooling layer, a softmax function, and a bounding box regressor.

Specifically, the first convolution neural network (Conv 1) may receive the whole image and the object candidate area simultaneously as inputs.

And the first convolution network processes the whole image at once through a convolution layer, a max-pooling layer, and/or an average pooling layer and generates a feature map that binds meaningful objects into feature areas.

Next, the second convolution network passes each object candidate area to the RoI pooling layer to extract a fixed-length feature vector from the feature map.

And the second convolution network applies the extracted feature vector to the Fully-Connected Layer (FCL) and then applies the output data of the FCL to the softmax function disposed at the final stage to specify the type of each object.

At this time, the second convolution network may be trained to extract only a fashion-related object from various types of objects.

Also, the second convolution network may extract a bounding box representing an area occupied by a fashion-related object by applying the output data of the fully connected layer to the bounding box regressor.

The fashion detector having the first convolution network and the second convolution network may specify that the type of an object in the input image is a fashion-related item and extract a feature area occupied by the corresponding product as a bounding box.

In other words, the search application 211 may specify that the type of an object in the input image is a fashion-related product and extract a feature area occupied by the corresponding product as a bounding box by performing deep learning using a deep-learning neural network trained to detect a fashion product.

In another example, the search application 211 may implement an interworking image deep-learning neural network using the Faster RCNN, MASK RCNN, and/or 1-stage object detector (SSD or YOLO family) model.

In the embodiment of the present disclosure, the object detection for an input image is performed based on the 2-stage object detector, Faster RCNN, MASK RCNN, and/or 1-stage object detector (SSD or YOLO family) model. However, this embodiment is only an example for illustration purposes and does not limit the method or algorithm for performing object detection on the input image.

Back to the description, the search application 211 which has detected at least one or more objects in the input image through the object detection and has generated a bounding box for the detected object may detect an object representing a target product from at least one or more objects in the input image based on the obtained product information.

And the search application 211 may obtain the main product image 1 based on the image of the bounding box for the detected target product object.

Specifically, the search application 211 according to the embodiment may detect a bounding box including an object matching the obtained product information from at least one or more bounding boxes obtained based on the trained image deep-learning neural network.

Also, the search application 211 may extract an image of the detected bounding box and set the extracted image as the main product image 1.

For example, when the category of the obtained product information is ‘dress,’ the search application 211 may detect a bounding box including a dress object from a plurality of objects detected from the input image.

And the search application 211 may generate the main product image 1 representing a predetermined area including the dress, which is the target product, based on the image area included in the detected bounding box.

As described above, by generating bounding boxes for at least one or more objects in an input image, detecting a bounding box including a target product from the generated bounding boxes, and setting the detected bounding box as the main product image 1, the search application 211 may extract only the area related to the target product to be searched by the user from the input image and attempt to reduce a data processing load and improve the search speed by performing subsequent functional operations for the product search service based on the extracted area.

Referring back to FIG. 5, the search application 211 that has obtained the main product image 1 according to the embodiment may determine whether the obtained main product image 1 includes an obstacle (step S105).

Specifically, the search application 211 according to the embodiment may determine whether the main product image 1 includes an object other than the target product (for example, a heterogeneous product and/or a human body).

Another embodiment may be described as a sequential process in which the search application 211 detects or determines the existence of an obstacle after the main product image 1 is detected. However, detecting or determining the existence of an obstacle during the object search operation or step may also be performed in a way of determining the presence of a bounding box of a different product within the bounding box of the target product or determining whether the bounding box of the different product overlaps the bounding box of the target product during the process of detecting a fashion object.

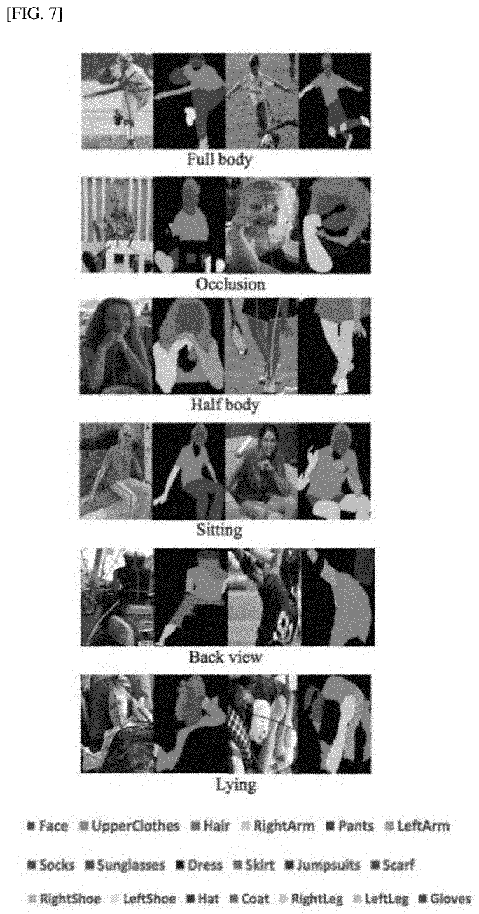

FIG. 7 illustrates an example of image segmentation according to an embodiment of the present disclosure.

Specifically, referring to FIG. 7, the search application 211 according to the embodiment may perform image segmentation of the main product image 1 using the image deep-learning neural network in conjunction with the product search server 400 or by the application's own process.

Here, the image segmentation according to the embodiment may be an operation or technique that partitions the whole image into at least one or more object areas, or an operation or technique that segments object areas in the whole image in pixel units.

At this time, for the image segmentation, the search application 211 according to the embodiment may use an image deep-learning neural network trained to detect an object (namely, an obstacle) other than the target product from the main product image 1 according to a predetermined criterion (for example, a pixel color distribution).

In other words, the search application 211 may perform the image segmentation using the pre-trained image deep-learning neural network. Through the image segmentation, the search application 211 determines whether an area including an obstacle, which is an element that hinders a product search, exists among the respective object areas segmented in the main product image 1.

As described above, by determining whether an obstacle, which is an element that hinders the product search (for example, a heterogeneous product or a human body), exists in the main product image 1 representing the target product, the search application 211 may proceed with a separate removal process subsequently in the existence of the obstacle in the main product image 1, thereby improving the accuracy of the product search for the target product.

Subsequently, when the search application 211, which has determined the existence of the obstacle in the obtained main product image 1, determines that the obstacle exists in the main product image 1, the search application 211 may remove the obstacle from the corresponding main product image 1 (step S107).

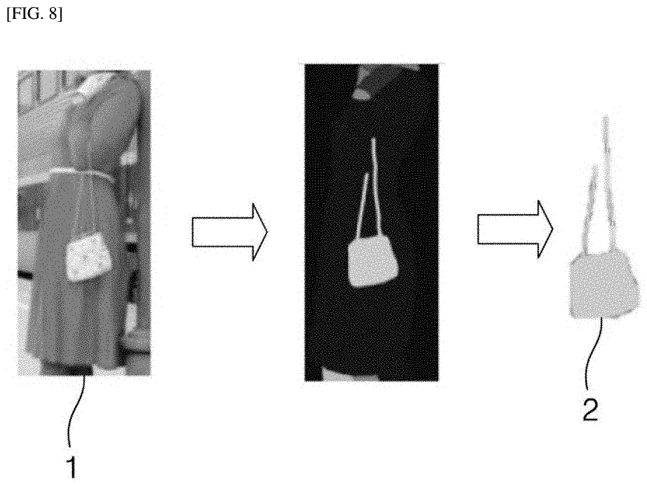

FIG. 8 shows an example of acquiring an obstacle image using image segmentation according to an embodiment of the present disclosure.

Specifically, referring to FIG. 8, when an object other than a target product (for example, a heterogeneous product and/or a human body) exists in the main product image 1, the search application 211 according to the embodiment may obtain an obstacle image 2 based on a predetermined area (e.g. a partial area of the main product image 1) representing the corresponding object (namely, the obstacle).

In other words, the obstacle image 2 according to the embodiment may be an image generated based on an area representing an object other than the target product (i.e. obstacle) in the main product image 1.

For example, the search application 211 may perform the image segmentation on the main product image 1, of which the target product is a dress, based on the image deep-learning neural network.

And the search application 211 may detect an area representing a handbag object (namely, a different, heterogeneous product other than the dress, the target product), which is an obstacle existing in the corresponding main product image 1, based on the image segmentation performed.

Also, the search application 211 may acquire the obstacle image 2 for the corresponding main product image 1 based on the obstacle area representing the detected handbag object.

Also, the search application 211 according to the embodiment may perform image processing that removes an obstacle from the corresponding main product image 1 based on the obstacle image 2 obtained as above.

And the search application 211 may obtain a loss image, which is an image from which an obstacle area has been removed, from the main product image 1 through image processing that removes the obstacle.

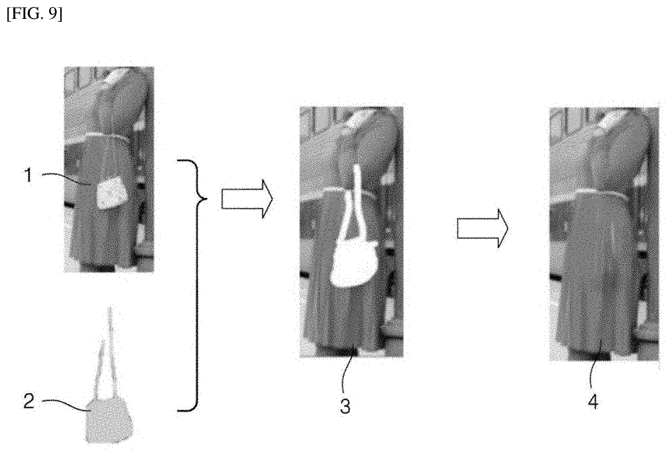

FIG. 9 illustrates a method for acquiring a loss image and a restored image according to an embodiment of the present disclosure.

Specifically, based on the obstacle image 2, the search application 211 according to the embodiment may generate a mask for at least part of the corresponding main product image 1.

The search application 211 according to the embodiment may generate a mask implemented to have the same area as occupied by the obstacle image 2.

And the search application 211 may perform a deletion process on at least part of the main product image 1 based on the generated mask.

For example, the search application 211 may remove only the obstacle image area from the main product image 1 by removing pixel values of the area corresponding to the mask from the main product image 1.

Through the removal operation, the search application 211 according to the embodiment may obtain a loss image 3, an image from which an area occupied by the obstacle image 2 has been removed, from the main product image 1.

For example, supposing that the obstacle image 2 corresponding to an area representing a handbag, a heterogeneous product different from a dress, exists in the main product image 1 in which the target product is the dress, based on the corresponding obstacle image 2, the search application 211 may obtain the loss image 3 on which image processing for deleting the handbag area from the corresponding main product image 1 has been performed.

In another example, supposing that an obstacle image 2 corresponding to an area representing the human body (for example, hand), a different object other than the handbag, exists in the main product image 1 in which the target product is the handbag, based on the corresponding obstacle image 2, the search application 211 may obtain the loss image 3 on which image processing for deleting the human body area from the corresponding main product image 1.

By removing an obstacle object from the main product image 1 representing a target product, the search application 211 according to the embodiment may minimize the problem of the conventional art that the feature vector of an obstacle may reflected on the main product image 1 at the time of a subsequent product search based on the feature vector of the target product, thereby improving the quality of a product search.

Also, the search application 211 according to the embodiment may perform image restoration on the main product image 1 from which an obstacle has been removed (namely, the loss image 3) (step S109).

Specifically, referring further to FIG. 9, the search application 211 may perform image inpainting on the loss image 3 based on the image deep-learning neural network in conjunction with the product search server 400 or by the application's own process.

Here, the image inpainting according to the embodiment may refer to an operation or technique that performs image restoration on a loss area (namely, the area removed from the main product image 1) of an input image (namely, the loss image 3).

Also, the search application 211 according to the embodiment may obtain the restored image 4, which is an image obtained by performing restoration on the loss image 3, based on the image inpainting performed through the image deep-learning neural network.

At this time, the search application 211 may obtain the restored image 4 for an input image (namely, the loss image 3) by using the image deep-learning neural network trained to perform the image inpainting on the corresponding input image.

In other words, the search application 211 according to the embodiment may perform loss restoration on the main product image 1 in which a predetermined loss has occurred due to deletion of an obstacle area by performing the image inpainting based on a pre-trained image deep-learning neural network and thus obtain the restored image 4.

For example, the search application 211 may perform restoration of a feature vector for the deleted area of the loss image 3 by performing the image inpainting based on the deep-learning neural network and thus can generate the restored image 4 for the corresponding loss image 3.

For example, in the case of the loss image 3 from which an obstacle area representing the handbag, a heterogeneous product, has been deleted, the search application 211 may perform the image inpainting using the image deep-learning neural network based on the corresponding loss image 3 from the main product image 1 in which the target product is a ‘dress’ and obtain the restored image 4 that restores a predetermined loss (for example, a feature vector loss within the dress image area) occurred due to the deletion of the corresponding handbag obstacle area.

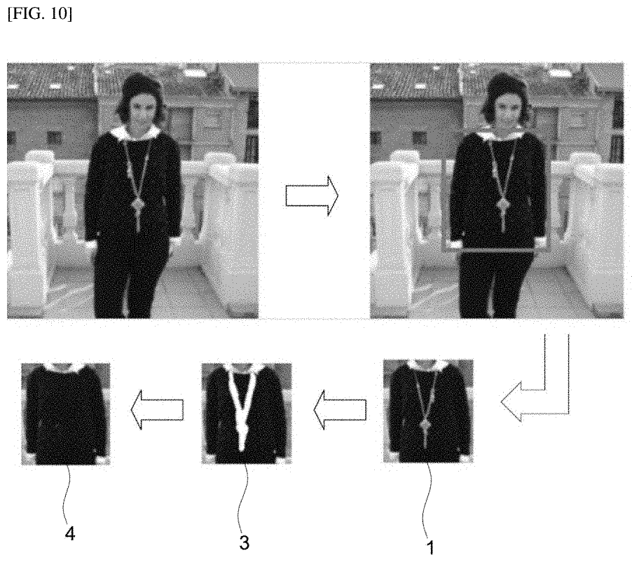

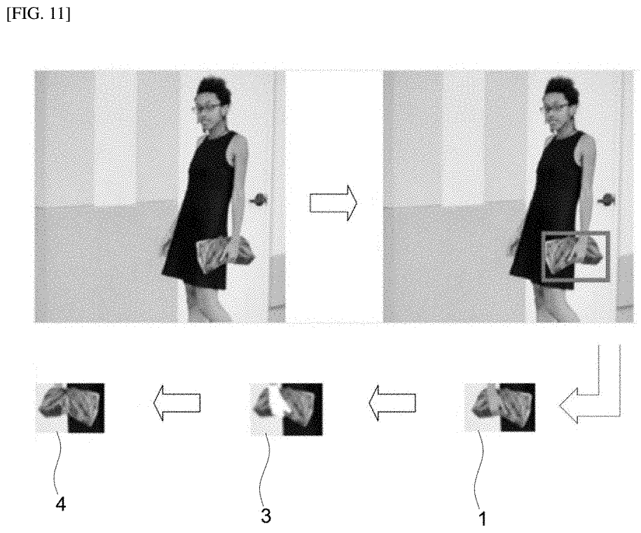

FIGS. 10 and 11 are examples for illustrating an image transformation process in a method for performing product search based on image restoration according to an embodiment of the present disclosure.

Referring to FIG. 10, in the case of a loss image from which an obstacle area representing the accessory, a heterogeneous product, has been deleted, the search application 211 may perform image inpainting using the image deep-learning neural network based on the corresponding loss image 3 from the main product image 1 in which the target product is a ‘top’ and obtain the restored image 4 that restores a predetermined loss (for example, a feature vector loss within the top image area) occurred due to the deletion of the corresponding accessory obstacle area.

In another example, referring to FIG. 11, in the case of a loss image 3 from which an obstacle area representing the human body (for example, hand), a different object other than the corresponding target product, has been deleted, the search application 211 may perform image inpainting using the image deep-learning neural network based on the corresponding loss image 3 from the main product image 1 in which the target product is a ‘handbag’ and obtain the restored image 4 that restores a predetermined loss (for example, a feature vector loss within the handbag image area) occurred due to the deletion of the corresponding human body area.

As described above, by performing the restoration on the main product image at least part of which has been damaged due to the deletion of an obstacle area, the search application 211 according to the embodiment may minimize a loss for a feature vector of the target product in the main product image 1. Thus, the search application 211 may prevent degradation of quality and distortion of a product search result due to the loss area.

Also, the search application 211 according to the embodiment may detect a feature vector based on the reconstructed image (for example, the restored image 4) (step S111).

In what follows, for an effective description, descriptions overlapping with those given above regarding the process of extracting a feature vector from an image may be summarized or omitted.

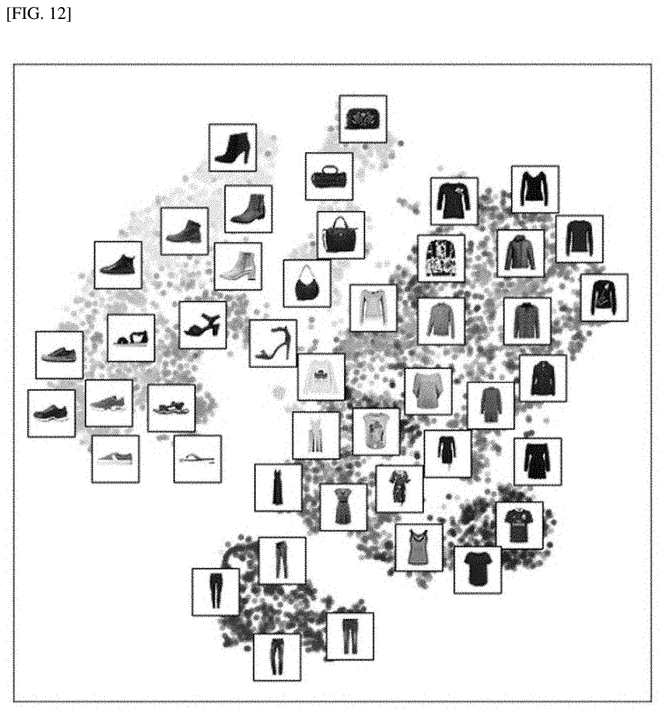

FIG. 12 is an example of graphic imagination of feature vectors by 2D transformation according to an embodiment of the present disclosure.

Referring to FIG. 12, the search application 211 may perform image deep-learning based on the restored image 4 in conjunction with the product search server 400 or by the application's own process.

At this embodiment, the search application 211 may perform image deep-learning based on the restored image 4 using the image deep-learning neural network trained to extract a feature vector from the input image.

Here, the image deep-learning neural network trained to extract a feature vector may extract each feature vector value for at least one or more parameters among the texture, fabric, shape, style, and color parameters by using each feature vector extraction image deep-learning neural network for each parameter.

More specifically, the search application 211 according to the embodiment may perform image deep-learning based on the restored image 4 using the feature vector extraction image deep-learning neural network trained as described above.

And the search application 211 may extract a feature vector for the corresponding restored image 4 based on the image deep-learning performed.

Specifically, the search application 211 according to the embodiment may extract a feature vector for the restored image 4 in conjunction with the extraction vector extraction image deep-learning neural network.

At this time, the feature vector extraction image deep-learning neural network performing the image deep-learning as described above may be implemented using a deep-learning neural network in the form of a general classifier (for example, ResNet and/or ResNeXt). However, the present disclosure is not limited to the neural network model described above.

The feature vector extraction image deep-learning neural network in the form of a general classifier may generate a feature map representing a feature area of the target product object in the corresponding restored image 4 by performing image processing of the restored image 4.

Also, the feature vector extraction image deep-learning neural network may extract a fixed-length feature vector from the feature map generated for the target product object included in the restored image 4.

In other words, the search application 211 according to the embodiment may detect a feature vector for the target product object included in the restored image 4 by performing image deep-learning using the trained feature vector extraction image deep-learning neural network.

More specifically, the search application 211 according to the embodiment may perform the training of the deep-learning model using various fashion product images when there is a deep-learning model (e.g. deep-learning neural network) based on fashion product images.

Also, the search application 211 may obtain a filter capable of distinguishing a fashion product object from other objects in various fashion product images through the training process.

For example, the search application 211 may perform low-level learning for horizontal, vertical, and curved lines on the object in the first layer of the deep-learning model.

Also, the search application 211 may perform middle-level learning for a specific element constituting the object (for example, pattern, color, and/or texture) through the second layer.

Also, the search application 211 may perform high-level learning for the entire outline of the object in the third layer.

Afterward, the search application 211 according to the embodiment may input the feature map obtained through the learning to the softmax function included in the final layer of the deep-learning model, through which the object may be classified to a predetermined category.

As described above, the search application 211 may train a deep-learning model as a classifier capable of distinguishing a predetermined object from other objects among various fashion product images.

At this time, the feature vector may mean a feature map of a particular layer among a plurality of layers before passing through the softmax.

In the example above, except for the fashion product image initially input to the network, a total of four convolution layers may be employed, and one of the feature maps from the layers may be selected to be used as a feature vector.

Also, the search application 211 according to the embodiment may perform a product search based on a detected feature vector and provide a result of the product search performed.

Specifically, the search application 211 may perform a product search based on a feature vector detected from the restored image 4 using a feature vector database constructed in conjunction with the shopping mall server 500.

More specifically, the search application 211 according to the embodiment may read out, from the feature vector database, a product having a feature vector of which the similarity to the feature vector obtained from the restored image 4 satisfies a preconfigured criterion (for example, greater than or equal to a predetermined percentage) in conjunction with the product search server 400 or by the application's own process.

The search application 211 according to the embodiment may search the feature vector database based on various algorithms models (for example, FLANN, Annoy, and/or Brute Force search).

At this time, the search application 211 may compare the feature vector of the restored image 4 with a feature vector for at least one or more products of the feature vector database and measure the similarity between the feature vectors from the comparison.

And the search application 211 may detect top n (n is a positive integer that is equal to or greater than 1) products of which the measured similarity satisfies a preconfigured criterion (for example, greater than or equal to a predetermined percentage).

Also, the search application 211 may retrieve or obtain information related to the detected top n products (for example, information on a shopping mall selling the corresponding product, product information on the corresponding product, and/or image information) from the memory 210, 310 and/or a database of an external server.

Also, the search application 211 according to the embodiment may output the information related to an obtained product, namely, the information on a product search result based on the feature vector of the restored image 4 on the display 271, 371 to provide the information to a user.

As described above, the search application 211 may perform a product search on an online shopping mall based on a feature vector of the restored image 4 and provide information on the product search result. From the product search, the search application 211 may provide a highly reliable product search result based on more accurate and objective feature vector data, thereby improving the competitiveness of the online shopping mall and user satisfaction.

As described above, a method and a system for product search based on image restoration according to an embodiment of the present disclosure may perform deep learning on images used for a product search in an online shopping mall and perform an image-based product search based on an image restored after removing an obstacle in the existence of the corresponding obstacle at the time of the product search, thereby improving the accuracy and quality of an image-based product search service.

Also, a method and a system for product search based on image restoration according to an embodiment of the present disclosure may implement a product search service in an online shopping mall by performing image-based deep learning, thereby providing an effect of providing not only the convenience of basic usability of the online shopping mall but also increasing the competitiveness of the online shopping mall.

Also, a method and a system for product search based on image restoration according to an embodiment of the present disclosure may implement a product search service in an online shopping mall through deep learning using a trained deep-learning neural network, thereby detecting and providing a product search result more accurately and quickly.

Also, the embodiments of the present disclosure described above may be implemented in the form of program commands which may be executed through various types of computer means and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include a magnetic medium such as a hard-disk, a floppy disk, and a magnetic tape; an optical medium such as a CD-ROM and a DVD; a magneto-optical medium such as a floptical disk; and a hardware device specially designed to store and execute program commands such as a ROM, a RAM, and a flash memory. Examples of program commands include not only machine code such as one created by a compiler but also high-level language code which may be executed by a computer through an interpreter and the like. The hardware device may be configured to be operated by one or more software modules to perform the operations of the present disclosure, and vice versa.

Specific implementation of the present disclosure is one embodiment, which does not limit the technical scope of the present disclosure in any way. For the clarity of the disclosure, descriptions of conventional electronic structures, control systems, software, and other functional aspects of the systems may be omitted. Also, connection of lines between constituting elements shown in the figure or connecting members illustrate functional connections and/or physical or circuit connections, which may be replaced in an actual device or represented by additional, various functional, physical, or circuit connection. Also, if not explicitly stated otherwise, “essential” or “important” elements may not necessarily refer to constituting elements needed for application of the present disclosure.

Also, although detailed descriptions of the present disclosure have been given with reference to preferred embodiments of the present disclosure, it should be understood by those skilled in the corresponding technical field or by those having common knowledge in the corresponding technical field that the present disclosure may be modified and changed in various ways without departing from the technical principles and scope specified in the appended claims. Therefore, the technical scope of the present disclosure is not limited to the specifications provided in the detailed descriptions of this document but has to be defined by the appended claims.

What is claimed is:

1. A method for performing a product search using deep-learning based image restoration by a product search application executed by a computing device, the method comprising:
receiving an input image including a target product to be searched;
detecting one or more objects including the target product from the input image through object detection;
determining the target product among a plurality of products and obtaining a main product image representing the determined target product;
determining whether an obstacle, which is an object other than the target product, is included in the main product image;
if the obstacle is included in the main product image, generating a loss image by removing the obstacle from the main product image;
obtaining a restored image by performing image restoration on the loss image using deep learning;
performing a product search, which searches for a product similar to the target product, based on the restored image obtained by performing the image restoration on the loss image, in which the obstacle is removed from the main product image representing the target product, by the deep learning; and
outputting a result of the product search.

2. The method of claim 1, wherein the main product image is an image including an area for an object representing the target object among one or more objects included in the input image.

3. The method of claim 2, wherein the obtaining of the main product image includes determining, among bounding boxes for one or more objects detected from the input image based on the deep learning, an image area of a bounding box including an object of the target product as the main product image.

4. The method of claim 1, wherein the determining of whether the obstacle, which is the object other than the target product, is included in the main product image comprises determining that the obstacle is included in the main product image when there is an overlapping area between a bounding box of the target product and a bounding box of another object which does not include the target product.

5. The method of claim 1, wherein the determining of whether the obstacle, which is the object other than the target product, is included in the main product image includes performing semantic segmentation on the main product image to classify a plurality of areas of the main product image according to a respective label of each area and when a target product area designated by a label of the target product includes an area of another label which is not the label of the target product, determining that the obstacle is included in the target product area.

6. The method of claim 1, wherein the generating of the loss image includes:
obtaining an obstacle image generated based on an area representing the obstacle, and obtaining a loss image that removes the area representing the obstacle from the main product image by performing image processing on the main product image based on the obstacle image.

7. The method of claim 1, wherein the generating of the loss image includes:
classifying an area of the main product image into a first area indicated by a target product label and a second area indicated by an obstacle label through semantic segmentation;
generating a mask for the second area indicated by the obstacle label; and
obtaining the loss image by removing an area corresponding to the mask from the main product image.

8. The method of claim 1, wherein the restored image is an image in which image restoration is performed on a loss area generated by removing an area representing the obstacle from the main product image.

9. The method of claim 8, wherein the obtaining of the restored image by performing the image restoration on the loss image based on the deep learning includes inputting the loss image into an image deep-learning neural network trained to perform inpainting and outputting a restored image that restores the removed area representing the obstacle by the image deep-learning neural network.

10. The method of claim 1, wherein the performing of the product search that searches for the product similar to the target product based on the restored image includes:
extracting a feature vector by inputting the restored image into an image deep-learning neural network; and
searching a database that stores feature vectors of the plurality of products based on the extracted feature vector.

11. The method of claim 10, wherein the performing of the product search that searches for the product similar to the target product includes detecting, from the database, a product having a feature vector having similarity to the feature vector of the restored image which satisfies a predetermined criterion.

12. A system for performing a product search based on image restoration, the system comprising:
a computing device executing a product search application configured to perform a product search using deep-learning based image restoration;
a product search server configured to operate in association with the product search application; and
a shopping mall server configured to provide data required for the product search for an online shopping mall service, wherein
the computing device is configured to:
receive an input image including a target product to be searched,
detect one or more objects including the target product from the input image through object detection, determine the target product among a plurality of products, obtain a main product image representing the determined target product, and determine whether an obstacle, which is an object other than the target product, is included the main product image; and
the computing device is configured to:
if the obstacle is included in the main product image, generate a loss image by removing the obstacle from the main product image, obtain a restored image by performing image restoration on the loss image using deep learning, perform a product search, which searches for a product similar to the target product, based on the restored image obtained by performing the image restoration on the loss image, in which the obstacle is removed from the main product image representing the target product, by the deep learning, and output a result of the product search.

13. The system of claim 12, wherein the computing device determines, among bounding boxes for one or more objects detected from the input image based on the deep learning, an image area of a bounding box including an object of the target product as the main product image.

14. The system of claim 12, wherein the computing device determines that the obstacle is included in the main product image when there is an overlapping area between a bounding box of the target product and a bounding box of another object which does not include the target product.

15. The system of claim 12, wherein the computing device performs semantic segmentation on the main product image to classify a plurality of areas of the main product image according to a respective label of each area and when a target product area designated by a label of the target product includes an area of another label which is not the label of the target product, determines that the obstacle is included in the target product area.

16. The system of claim 12, wherein the computing device obtains an obstacle image generated based on an area representing the obstacle and obtains a loss image that removes the area representing the obstacle from the main product image by performing image processing on the main product image based on the obstacle image.

17. The system of claim 12, wherein the computing device classifies an area of the main product image into a first area indicated by a target product label and a second area indicated by an obstacle label through semantic segmentation; generates a mask for the second area indicated by the obstacle label; and obtains the loss image by removing an area corresponding to the mask from the main product image.

18. The system of claim 12, wherein the restored image is an image in which image restoration is performed on a loss area generated by removing an area representing the obstacle from the main product image.

19. The system of claim 18, wherein the computing device inputs the loss image into an image deep-learning neural network trained to perform inpainting and outputs a restored image that restores the removed area representing the obstacle by the image deep-learning neural network.

20. The system of claim 12, wherein the computing device extracts a feature vector by inputting the restored image into an image deep-learning neural network and searches a database that stores feature vectors of the plurality of products based on the extracted feature vector.
